(19) United States
(12) Patent Application Publication
(10) Pub. No.: US 2026/0074720 A1
(43) Pub. Date: Mar. 12, 2026

(54) Circuitry with Transmission Line-Based Signal Attenuators

(71) Applicant: Apple Inc., Cupertino, CA (US)

(72) Inventors: Hongrui Wang, San Jose, CA (US); Hideya Oshima, Santa Clara, CA (US); Hamidreza Kazemi Varnamkhasti, San Diego, CA (US); Abbas Komijani, Mountain View, CA (US)

(21) Appl. No.: 18/883,998

(22) Filed: Sep. 12, 2024

(51) Int. Cl. H04B 1/04

(52) U.S. Cl. CPC H04B 1/04

(57) ABSTRACT

An electronic device may include a signal path that conveys a signal. The device may include an attenuator on the signal path that attenuates the signal. The attenuator may be free from series switches on the signal path. The attenuator may include a transmission line segment coupled in series between an input and an output of the attenuator. The transmission line segment may extend from a first terminal to a second terminal. A first adjustable resistance may couple the first terminal to ground. A second adjustable resistance may couple the second terminal to ground. The transmission line segment may have a length configured to perform impedance matching for the attenuator. A controller may control an attenuation level of the signal attenuator by adjusting the magnitude of the adjustable resistances. The controller may include a servo loop around an operational amplifier to mitigate process, voltage, and temperature variations in the attenuator.

### FIELD

This disclosure relates generally to electronic devices and, more particularly, to electronic devices with communications circuitry.

### BACKGROUND

Electronic devices are often provided with communications capabilities. An electronic device with communications capabilities has communications circuitry with a signal path that conveys a signal.

It can be challenging to ensure that the signal is conveyed along the signal path at desired signal levels.

### SUMMARY

An electronic device may include a signal path that conveys a signal at a wavelength. The device may include a signal attenuator disposed on the signal path. The signal attenuator may attenuate the signal. The signal attenuator may be free from series switches on the signal path.

The signal attenuator may include a transmission line segment coupled in series between an input and an output of the signal attenuator. The transmission line segment may extend from a first terminal to a second terminal. A first adjustable resistance may couple the first terminal to ground. A second adjustable resistance may couple the second terminal to ground. The transmission line segment may have a length configured to perform impedance matching for the attenuator. The length may be one-quarter, one-half, or one-eighth the wavelength, as just three examples. A controller may control an attenuation level of the signal attenuator by adjusting the magnitude of the adjustable resistances. The controller may include a servo loop around an operational amplifier to help mitigate process, voltage, and temperature variations in the attenuator.

An aspect of the disclosure provides circuitry. The circuitry can include a signal path configured to convey a radio-frequency signal. The circuitry can include an adjustable attenuator disposed on the signal path and configured to attenuate the radio-frequency signal.

The adjustable attenuator has an input terminal and an output terminal. The adjustable attenuator can include a transmission line segment coupled in series between the input terminal and the output terminal, a first adjustable resistance coupled between a first terminal of the transmission line segment and a reference potential, and a second adjustable resistance coupled between a second terminal of the transmission line segment and the reference potential.

An aspect of the disclosure provides a radio-frequency signal attenuator disposed on a signal line. The radio-frequency signal attenuator can include a transmission line extending from a first terminal to a second terminal, the first terminal being coupled to an input of the radio-frequency signal attenuator and the second terminal being communicatively coupled to an output of the radio-frequency signal attenuator. The radio-frequency signal attenuator can include a first adjustable resistance that couples the first terminal to a ground. The radio-frequency signal attenuator can include a second adjustable resistance that couples the second terminal to the ground, wherein the transmission line has a length from the first terminal to the second terminal that is configured to match an input impedance of the radio-frequency signal attenuator to an impedance of the signal line.

An aspect of the disclosure provides an electronic device. The electronic device can include a signal path configured to convey a radio-frequency signal. The electronic device can include an attenuator disposed on the signal path, wherein the attenuator is configured to attenuate the radio-frequency signal and includes first and second adjustable shunt resistances. The electronic device can include a controller configured to adjust a magnitude of the first and second adjustable shunt resistances. The controller can include an operational amplifier having an output communicatively coupled to the first and second adjustable shunt resistances. The controller can include a set of transistors having gate terminals communicatively coupled to the output of the operational amplifier. The controller can include a servo loop extending around the operational amplifier from the output of the operational amplifier to a first input of the operational amplifier through the set of transistors.

### BRIEF DESCRIPTION OF THE DRAWINGS

FIG. 1 is a schematic diagram of an illustrative electronic device having wireless circuitry in accordance with some embodiments.

FIG. 2 is a schematic diagram of illustrative wireless circuitry in accordance with some embodiments.

FIG. 3 is a diagram of an illustrative signal path that includes signal attenuators in accordance with some embodiments.

FIG. 4 is a diagram of an illustrative signal path that may be provided with a signal attenuator at one or more locations along the signal path in accordance with some embodiments.

FIG. 5 is a circuit diagram of an illustrative quarter-wavelength transmission line-based signal attenuator in accordance with some embodiments.

FIG. 6 is a Smith chart for an illustrative quarter-wavelength transmission line-based signal attenuator of the type shown in FIG. 5 in accordance with some embodiments.

FIG. 7 is a circuit diagram of an illustrative eighth-wavelength transmission line-based signal attenuator in accordance with some embodiments.

FIG. 8 is a circuit diagram of an illustrative half-wavelength transmission line-based signal attenuator in accordance with some embodiments.

FIG. 9 is a circuit diagram of an illustrative controller for a transmission line-based signal attenuator in accordance with some embodiments.

FIG. 10 is a plot showing how an illustrative controller of the type shown in FIG. 9 may minimize process, voltage, and temperature variations for a transmission line-based signal attenuator in accordance with some embodiments.

FIG. 11 is a diagram showing how an illustrative transmission line segment may be implemented as a lumped LC circuit in accordance with some embodiments.

### DETAILED DESCRIPTION

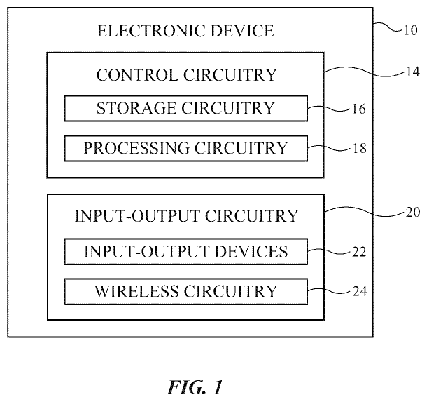

Electronic device 10 of FIG. 1 may be a computing device such as a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses, goggles, a helmet, or other equipment worn on a user's head (e.g., an augmented, virtual, or mixed reality head-mounted display device), or another wearable or miniature device, a television, a computer display that does not contain an embedded computer, a gaming device, a navigation device, an embedded system such as a system in which electronic equipment with a display is mounted in a kiosk or automobile, a wireless internet-connected voice-controlled speaker, a home entertainment device, a remote control device, a gaming controller, a peripheral user input device, a wireless base station or access point, equipment that implements the functionality of two or more of these devices, or other electronic equipment.

As shown in the schematic diagram FIG. 1, device 10 may include components located on or within an electronic device housing such as housing 12. Housing 12, which may sometimes be referred to as a case, may be formed of plastic, glass, ceramics, fiber composites, metal (e.g., stainless steel, aluminum, metal alloys, etc.), other suitable materials, or a combination of these materials. In some situations, part or all of housing 12 may be formed from dielectric or other low-conductivity material (e.g., glass, ceramic, plastic, sapphire, etc.). In other situations, housing 12 or at least some of the structures that make up housing 12 may be formed from metal elements.

Device 10 may include control circuitry 14. Control circuitry 14 may include storage such as storage circuitry 16. Storage circuitry 16 may include hard disk drive storage, nonvolatile memory (e.g., flash memory or other electrically-programmable-read-only memory configured to form a solid-state drive), volatile memory (e.g., static or dynamic random-access-memory), etc. Storage circuitry 16 may include storage that is integrated within device 10 and/or removable storage media.

Control circuitry 14 may include processing circuitry such as processing circuitry 18. Processing circuitry 18 may be used to control the operation of device 10. Processing circuitry 18 may include on one or more processors such as microprocessors, microcontrollers, digital signal processors, host processors, baseband processor integrated circuits, application specific integrated circuits, central processing units (CPUs), graphics processing units (GPUs), etc. Control circuitry 14 may be configured to perform operations in device 10 using hardware (e.g., dedicated hardware or circuitry), firmware, and/or software. Software code for performing operations in device 10 may be stored on storage circuitry 16 (e.g., storage circuitry 16 may include non-transitory (tangible) computer readable storage media that stores the software code). The software code may sometimes be referred to as program instructions, software, data, instructions, or code. Software code stored on storage circuitry 16 may be executed by processing circuitry 18.

Control circuitry 14 may be used to run software on device 10 such as satellite navigation applications, internet browsing applications, voice-over-internet-protocol (VOIP) telephone call applications, email applications, media playback applications, operating system functions, etc. To support interactions with external equipment, control circuitry 14 may be used in implementing communications protocols. Communications protocols that may be implemented using control circuitry 14 include internet protocols, wireless local area network (WLAN) protocols (e.g., IEEE 802.11 protocols—sometimes referred to as Wi-Fi®), protocols for other short-range wireless communications links such as the Bluetooth® protocol or other wireless personal area network (WPAN) protocols, IEEE 802.11ad protocols (e.g., ultra-wideband protocols), cellular telephone protocols (e.g., 3G protocols, 4G (LTE) protocols, 3GPP Fifth Generation (5G) New Radio (NR) protocols, Sixth Generation (6G) protocols, sub-THz protocols, THz protocols, etc.), antenna diversity protocols, satellite navigation system protocols (e.g., global positioning system (GPS) protocols, global navigation satellite system (GLONASS) protocols, etc.), antenna-based spatial ranging protocols, optical communications protocols, or any other desired communications protocols. Each communications protocol may be associated with a corresponding radio access technology (RAT) that specifies the physical connection methodology used in implementing the protocol.

Device 10 may include input-output circuitry 20. Input-output circuitry 20 may include input-output devices 22. Input-output devices 22 may be used to allow data to be supplied to device 10 and to allow data to be provided from device 10 to external devices. Input-output devices 22 may include user interface devices, data port devices, and other input-output components. For example, input-output devices 22 may include touch sensors, displays, light-emitting components such as displays without touch sensor capabilities, buttons (mechanical, capacitive, optical, etc.), scrolling wheels, touch pads, key pads, keyboards, microphones, cameras, buttons, speakers, status indicators, audio jacks and other audio port components, digital data port devices, motion sensors (accelerometers, gyroscopes, and/or compasses that detect motion), capacitance sensors, proximity sensors, magnetic sensors, force sensors (e.g., force sensors coupled to a display to detect pressure applied to the display), etc. In some configurations, keyboards, headphones, displays, pointing devices such as trackpads, mice, and joysticks, and other input-output devices may be coupled to device 10 using wired or wireless connections (e.g., some of input-output devices 22 may be peripherals that are coupled to a main processing unit or other portion of device 10 via a wired or wireless link).

Input-output circuitry 20 may include wireless circuitry 24 to support wireless communications. Wireless circuitry 24 (sometimes referred to herein as wireless communications circuitry 24) may include one or more antennas. Wireless circuitry 24 may also include baseband processor circuitry, transceiver circuitry, amplifier circuitry, filter circuitry, switching circuitry, radio-frequency transmission lines, radio-frequency front end circuitry, and/or any other circuitry for transmitting and/or receiving radio-frequency signals using the antenna(s).

Wireless circuitry 24 may transmit and/or receive wireless signals within corresponding frequency bands of the electromagnetic spectrum (sometimes referred to herein as communications bands or simply as “bands”). The frequency bands handled by wireless circuitry 24 may include wireless local area network (WLAN) frequency bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), a Wi-Fi® 7 band, and/or other Wi-Fi® bands (e.g., from 1875-5160 MHz), wireless personal area network (WPAN) frequency bands such as the 2.4 GHz Bluetooth® band or other WPAN communications bands, cellular telephone frequency bands (e.g., bands from about 600 MHz to about 5 GHz, 3G bands, 4G LTE bands, 5G New Radio Frequency Range 1 (FR1) bands below 10 GHz, 5G New Radio Frequency Range 2 (FR2) bands between 20 and 60 GHz, etc.), other centimeter or millimeter wave frequency bands between 10-100 GHz, sub-THz frequency bands between around 100 GHz and 10 THz (e.g., 6G bands), near-field communications (NFC) frequency bands (e.g., at 13.56 MHz), satellite navigation frequency bands (e.g., a GPS band from 1565 to 1610 MHz, a Global Navigation Satellite System (GLONASS) band, a BeiDou Navigation Satellite System (BDS) band, etc.), ultra-wideband (UWB) frequency bands that operate under the IEEE 802.15.4 protocol and/or other ultra-wideband communications protocols, communications bands under the family of 3GPP wireless communications standards, communications bands under the IEEE 802.XX family of standards, and/or any other desired frequency bands of interest.

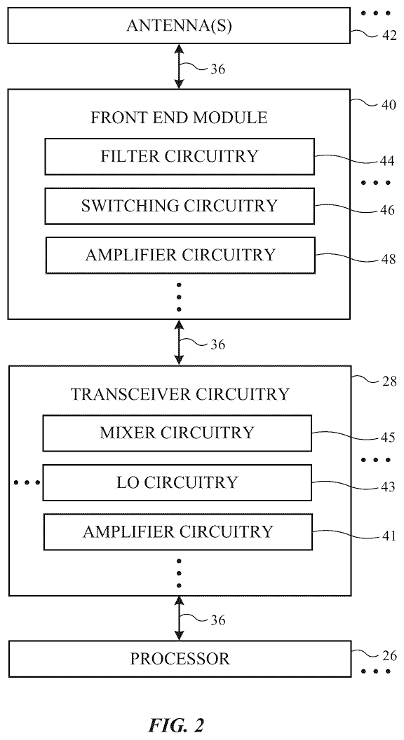

FIG. 2 is a diagram showing illustrative components within wireless circuitry 24. As shown in FIG. 2, wireless circuitry 24 may include one or more processors such as processor(s) 26, radio-frequency (RF) transceiver circuitry such as radio-frequency transceiver 28, radio-frequency front end circuitry such as radio-frequency front end module (FEM) 40, and antenna(s) 42. Processor 26 may include baseband circuitry (e.g., one or more baseband processors), an application processor, a digital signal processor, a microcontroller, a microprocessor, a central processing unit (CPU), a programmable device, an a combination of these circuits, and/or one or more processors within processing circuitry 18 of FIG. 1. Processor 26 may be configured to generate digital (transmit or baseband) signals. Processor 26 may be coupled to transceiver 28 over path 34 (sometimes referred to as a baseband path). Transceiver 28 may be coupled to antenna 42 via radio-frequency transmission line path. If desired, one or more radio-frequency front end modules such as radio-frequency front end module 40 may be disposed along radio-frequency transmission line path 36 between transceiver 28 and antenna 42.

Wireless circuitry 24 may include one or more antennas such as antenna 42. Antenna 42 may be formed using any desired antenna structures. For example, antenna 42 may be an antenna with a resonating element that is formed from loop antenna structures, patch antenna structures, inverted-F antenna (IFA) structures, slot antenna structures, planar inverted-F antenna (PIFA) structures, helical antenna structures, monopole antennas, dipoles, dielectric resonator antenna (DRA) structures, waveguide antenna structures, bowtie antenna structures, hybrids of these designs, etc. If desired, two or more antennas 42 may be arranged into one or more phased antenna arrays (e.g., for conveying radio-frequency signals at millimeter wave frequencies). If desired, parasitic elements may be included in antenna 42 to adjust antenna performance. If desired, antenna 42 may be provided with a conductive cavity that backs the antenna resonating element of antenna 42 (e.g., antenna 42 may be a cavity-backed antenna such as a cavity-backed slot antenna).

In the example of FIG. 2, wireless circuitry 24 is illustrated as including only a single processor 26, a single transceiver 28, a single front end module 40, and a single antenna 42 for the sake of clarity. In general, wireless circuitry 24 may include any desired number of processors 26, any desired number of transceivers 28, any desired number of front end modules 40, and any desired number of antennas 42. Each processor 26 may be coupled to one or more transceiver 28 over respective paths 34. Each transceiver 28 may include a transmitter circuit configured to output uplink signals to antenna 42, may include a receiver circuit configured to receive downlink signals from antenna 42, and may be coupled to one or more antennas 42 over respective radio-frequency transmission line paths 36. Each radio-frequency transmission line path 36 may have a respective front end module 40 disposed thereon. If desired, two or more front end modules 40 may be disposed on the same radio-frequency transmission line path 36. If desired, one or more of the radio-frequency transmission line paths 36 in wireless circuitry 24 may be implemented without any front end module disposed thereon.

Front end module (FEM) 40 may include radio-frequency front end circuitry that operates on the radio-frequency signals conveyed (transmitted and/or received) over radio-frequency transmission line path 36. Front end module may, for example, include front end module (FEM) components such as radio-frequency filter circuitry 44 (e.g., low pass filters, high pass filters, notch filters, band pass filters, multiplexing circuitry, duplexer circuitry, diplexer circuitry, triplexer circuitry, etc.), switching circuitry 46 (e.g., one or more radio-frequency switches), radio-frequency amplifier circuitry 48 (e.g., one or more power amplifiers and one or more low-noise amplifiers), impedance matching circuitry (e.g., circuitry that helps to match the impedance of antenna 42 to the impedance of radio-frequency transmission line 36), antenna tuning circuitry (e.g., networks of capacitors, resistors, inductors, and/or switches that adjust the frequency response of antenna 42), radio-frequency coupler circuitry, charge pump circuitry, power management circuitry, digital control and interface circuitry, and/or any other desired circuitry that operates on the radio-frequency signals transmitted and/or received by antenna 42. Each of the front end module components may be mounted to a common (shared) substrate such as a rigid printed circuit board substrate or flexible printed circuit substrate. If desired, the various front end module components may also be integrated into a single integrated circuit chip.

Filter circuitry 44, switching circuitry 46, amplifier circuitry 48, and other circuitry may be disposed along radio-frequency transmission line path 36, may be incorporated into FEM 40, and/or may be incorporated into antenna 42 (e.g., to support antenna tuning, to support operation in desired frequency bands, etc.). These components, sometimes referred to herein as antenna tuning components, may be adjusted (e.g., using control circuitry 14) to adjust the frequency response and wireless performance of antenna 42 over time.

Radio-frequency transmission line path 36 may be coupled to an antenna feed on antenna 42. The antenna feed may, for example, include a positive antenna feed terminal and a ground antenna feed terminal. Radio-frequency transmission line path 36 may have a positive transmission line signal path such that is coupled to the positive antenna feed terminal on antenna 42. Radio-frequency transmission line path 36 may have a ground transmission line signal path that is coupled to the ground antenna feed terminal on antenna 42. This example is illustrative and, in general, antennas 42 may be fed using any desired antenna feeding scheme. If desired, antenna 42 may have multiple antenna feeds that are coupled to one or more radio-frequency transmission line paths 36.

Radio-frequency transmission line path 36 may include one or more transmission lines that are used to route radio-frequency signals within device 10 (FIG. 1). Transmission lines in device 10 may include coaxial cables, microstrip transmission lines, stripline transmission lines, edge-coupled microstrip transmission lines, edge-coupled stripline transmission lines, transmission lines formed from combinations of transmission lines of these types, etc. Multiple transmission lines the radio-frequency transmission line path 36 may be coupled to each other using radio-frequencies connectors, radio-frequency signal couplers, radio-frequency signal splitters, and/or impedance matching circuitry.

A “transmission line path” or “radio-frequency transmission line path” as used herein can refer to and be defined herein as one or more transmission lines coupled between at least first and second nodes. The transmission line path conveys high frequency electromagnetic signals (e.g., radio-frequency signals at frequencies greater than or equal to around 20 kHz) between the at least first and second nodes with less than a threshold level of signal loss. A transmission line path is often terminated by one or more loads and/or impedance matching networks (e.g., at the at least first and second nodes) to prevent signal reflection and for reducing signal interference, degradation/distortion, and power loss (e.g., to help match impedances of the at least first and second nodes at radio frequencies to an impedance of the transmission line path such as a 50 ohm impedance).

Transmission lines in device 10 such as transmission lines in radio-frequency transmission line path 36 may be integrated into rigid and/or flexible printed circuit boards. In one suitable implementation, radio-frequency transmission line paths such as radio-frequency transmission line path 36 may also include transmission line conductors integrated within multilayer laminated structures (e.g., layers of a conductive material such as copper and a dielectric material such as a resin that are laminated together without intervening adhesive). The multilayer laminated structures may, if desired, be folded or bent in multiple dimensions (e.g., two or three dimensions) and may maintain a bent or folded shape after bending (e.g., the multilayer laminated structures may be folded into a particular three-dimensional shape to route around other device components and may be rigid enough to hold its shape after folding without being held in place by stiffeners or other structures). All of the multiple layers of the laminated structures may be batch laminated together (e.g., in a single pressing process) without adhesive (e.g., as opposed to performing multiple pressing processes to laminate multiple layers together with adhesive).

Transceiver 28 may include wireless local area network transceiver circuitry that handles WLAN communications bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), and/or other Wi-Fi® bands (e.g., from 1875-5160 MHz), wireless personal area network transceiver circuitry that handles the 2.4 GHz Bluetooth® band or other WPAN communications bands, cellular telephone transceiver circuitry that handles cellular telephone bands (e.g., bands from about 600 MHz to about 5 GHz, 3G bands, 4G LTE bands, 5G New Radio Frequency Range 1 (FR1) bands below 10 GHz, 5G New Radio Frequency Range 2 (FR2) bands between 20 and 60 GHz, 6G bands above 100 GHz, etc.), near-field communications (NFC) transceiver circuitry that handles near-field communications bands (e.g., at 13.56 MHz), satellite navigation receiver circuitry that handles satellite navigation bands (e.g., a GPS band from 1565 to 1610 MHz, a Global Navigation Satellite System (GLONASS) band, a BeiDou Navigation Satellite System (BDS) band, etc.), ultra-wideband (UWB) transceiver circuitry that handles communications using the IEEE 802.15.4 protocol and/or other ultra-wideband communications protocols, and/or any other desired radio-frequency transceiver circuitry for covering any other desired communications bands of interest.

The term “convey radio-frequency signals” as used herein means the transmission and/or reception of the radio-frequency signals (e.g., for performing unidirectional and/or bidirectional wireless communications with external wireless communications equipment). In performing wireless transmission, processor 26 may provide digital signals to transceiver 28 over path 34. Transceiver 28 may further include circuitry for converting the baseband signals received from processor 26 into corresponding intermediate frequency or radio-frequency signals. For example, transceiver 28 may include mixer circuitry 45 that up-converts (or modulates) the baseband signals to intermediate frequencies (e.g., as intermediate frequency (IF) signals), that up-converts the baseband signals to radio frequencies higher than the intermediate frequencies (e.g., as radio-frequency (RF) signals), and/or that up-converts IF signals to radio frequencies prior to transmission over antenna 42. Transceiver 28 may also include digital-to-analog converter (DAC) and/or analog-to-digital converter (ADC) circuitry that converts signals between digital and analog domains. Transceiver 28 may include amplifier circuitry 41 (e.g., one or more power amplifiers) that amplify the radio-frequency signals for transmission. Additionally or alternatively, one or more power amplifiers in amplifier circuitry 48 may amplify the radio-frequency signals for transmission. Transceiver 28 may include a transmitter that transmits the radio-frequency signals over antenna 42 via radio-frequency transmission line path 36 and front end module 40. Antenna 42 may transmit the radio-frequency signals to external wireless equipment by radiating the radio-frequency signals into free space (or into free space through a dielectric cover layer on device 10).

In performing wireless reception, antenna 42 may receive radio-frequency signals from external wireless equipment (e.g., from free space). The received radio-frequency signals may be conveyed to transceiver 28 via radio-frequency transmission line path 36 and front end module 40. One or more low noise amplifiers in amplifier circuitry 41 and/or amplifier circuitry 48 may amplify the received signals. Transceiver 28 may include circuitry for converting the received radio-frequency signals into corresponding intermediate frequency or baseband signals. For example, transceiver 28 may use mixer circuitry 45 to downconvert (or demodulate) the received radio-frequency signals to intermediate frequencies, to downconvert the received radio-frequency signals to baseband frequencies (e.g., as baseband signals or baseband data), and/or to downconvert IF signals to baseband frequencies prior to conveying the received signals to processor 26 over path 34. Mixer circuitry 45 can include local oscillator circuitry such as local oscillator (LO) circuitry 43. Local oscillator circuitry 43 can generate oscillator signals that mixer circuitry 45 uses to modulate transmit signals from baseband frequencies to radio frequencies and/or to demodulate received signals from radio frequencies to baseband frequencies.

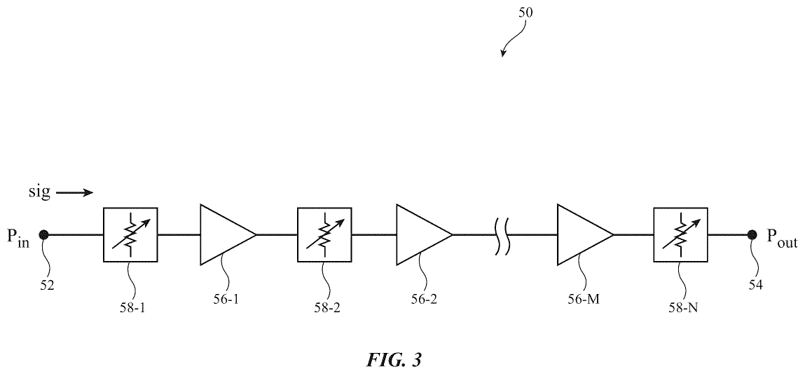

Electronic devices such as device 10 may include signal transmission circuitry that transmits an electrical signal on a signal path. FIG. 3 is a diagram of an illustrative signal path 50 in device 10. Signal path 50 is sometimes also referred to herein as signal transmission path 50, transmission path 50, or transmit path 50. As shown in FIG. 3, signal path 50 may be coupled between an input node 52 and an output node 54. Device 10 may include a signal source (not shown) communicatively coupled to input node 52. Device 10 may also include an output load communicatively coupled to output node 54.

Signal path 50 may transmit an electrical signal such as signal sig from input node 52 to output node 54. If desired, signal path 50 may be formed in wireless circuitry 24 (FIG. 1). Signal sig may be a radio-frequency signal or a baseband signal, as two examples. Implementations in which signal sig is a radio-frequency signal are described herein as an example. If desired, signal sig may carry wireless data (e.g., signal sig may be modulated and/or encoded to carry a stream of wireless symbols, packets, frames, datagrams, etc., that are transmitted to an external device, that are received from an external device, or that are conveyed between two components of device 10). As another example, signal sig may carry a spatial ranging waveform such as a radar waveform, may carry a reference signal waveform, or may have any other desired waveform.

In implementations where signal sig is a radio-frequency signal, signal path 50 may include all or a portion of a radio-frequency transmission line path 36 (FIG. 2) and is sometimes also referred to herein as radio-frequency signal path 50, radio-frequency path 50, radio-frequency transmission path 50, or radio-frequency transmit path 50. Signal path 50 may couple FEM 40 to antenna(s) 42, may couple FEM 40 to transceiver circuitry 28, may couple transceiver circuitry 28 to processor 26, may be disposed on FEM 40 and may extend between two components of FEM 40, and/or may be disposed on transceiver circuitry 28 and may extend between two components of transceiver circuitry 28.

The signal source coupled to input node 52 may include a transmitter in transceiver circuitry 28 (FIG. 2), a receiver in transceiver circuitry 28, baseband circuitry in processor 26, an amplifier in amplifier circuitry 41, an amplifier in amplifier circuitry 48, a switch in switching circuitry 46, a filter in filter circuitry 44, an antenna 42, a signal generator, a synthesizer, a mixer in mixer circuitry 45, a mixer in FEM 40, and/or any other desired signal source. Conversely, the output load coupled to output node 54 may include a transmitter in transceiver circuitry 28 (FIG. 2), a receiver in transceiver circuitry 28, baseband circuitry in processor 26, an amplifier in amplifier circuitry 41, an amplifier in amplifier circuitry 48, a switch in switching circuitry 46, a filter in filter circuitry 44, an antenna 42, a signal generator, a synthesizer, a mixer in mixer circuitry 45, a mixer in FEM 40, and/or any other desired output load.

This example is illustrative and non-limiting and, in general, signal path 50 may be any desired signal path in device 10 and signal sig may be at any desired frequencies. Signal path 50 may, if desired, convey signal sig within or between different boards, packages, nodes, chips, integrated circuits, processors, components, accessories, devices such as device 10, etc.

Signal path 50 may receive signal sig at an input power level Pᵢₙ. Signal path 50 may output signal sig at an output power level Pₒᵤₜ. Signal path 50 may include a set of M circuit components 56 disposed along the signal path (e.g., a first component 56-1, a second component 56-2, an Mth component 56-M, etc.). M may be any desired integer greater than or equal to zero. Component(s) 56 may be components that are configured to adjust the signal level (e.g., voltage level, magnitude, amplitude, power level, etc.) of the signal sig propagating along signal path 50. Component(s) 56 may, for example, include amplifiers (e.g., power amplifiers (PAs), low noise amplifiers (LNAs), gain stages, amplifier stages, etc.), signal splitters, signal combiners, signal couplers, mixers, transformers, DC-to-DC converters, and/or any other components that adjust the signal level of signal sig.

In practice, it may be desirable to tune the amplitude of signal sig after the signal has been operated on by a component 56 (e.g., to tune the level of the signal to match a desired level not achievable with component 56 on its own) and/or prior to providing signal sig to a component 56 (e.g., to tune the level of the signal to match an optimal range of input levels associated with that component 56). As such, signal path 50 may include a set of N signal attenuators 58 between input node 52 and output node 54 (e.g., a first signal attenuator 58-1, a second signal attenuator 58-2, an Nth signal attenuator 58-N, etc.). N may be any desired integer greater than or equal to one.

Signal attenuator(s) 58 may be coupled to the input of a corresponding component 56, to the input of signal path 50 (see, e.g., signal attenuator 58-1 coupled between the input of component 56-1 and input node 52), to the output of a corresponding component 56, to the output of signal path 50 (see, e.g., signal attenuator 58-N coupled between the output of component 56-M and output node 54), and/or between a first component 56 and a second component 56 (see, e.g., signal attenuator 58-2 coupled between component 56-1 and component 56-2). Each signal attenuator 58 may receive signal sig and may attenuate (reduce) the signal level of signal sig (e.g., voltage level, magnitude, amplitude, power level, etc.) by a desired amount (attenuation level). If desired, one or more signal attenuators 58 may be adjustable to change the amount of attenuation produced by the signal attenuator over time. The N signal attenuators 58 and the M components 56 on signal path 50 may collectively convert signal sig from input power level Pᵢₙ at input node 52 to output power level Pₒᵤₜ at output node 54.

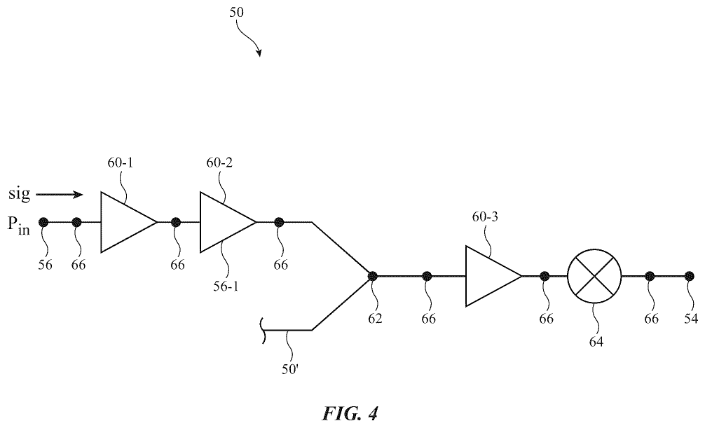

FIG. 4 is a circuit diagram showing one exemplary implementation of signal path 50 in which the components 56 on signal path 50 include at least three amplifiers 60-1, 60-2, and 60-3, a signal combiner (adder) 62, and a mixer 64. As shown in FIG. 4, amplifier 60-1 may be disposed on signal path 50 between amplifier 60-2 and input node 56. Amplifier 60-2 may be disposed on signal path 50 and signal combiner 62. Amplifiers 60-1 and 60-2 may each amplify the signal sig received at input node 56.

An additional signal path 50′ may be coupled to signal path 50 by signal combiner 62. Signal combiner 62 may increase the power of the signal sig propagating along signal path 50 by combining power from signal path 50′ onto signal path 50. Amplifier 60-3 may be disposed on signal path 50 between signal combiner 62 and mixer 64. Amplifier 60-3 may further amplify signal sig. Mixer 64 may upconvert signal sig (e.g., from baseband to an intermediate frequency or radio frequency or from an intermediate frequency to a radio frequency) or may downconvert signal sig (e.g., from a radio frequency to an intermediate frequency or baseband or from an intermediate frequency to baseband) prior to outputting signal sig on output node 54.

In this implementation, one or more signal attenuators 58 (FIG. 3) may be disposed at any desired number of the nodes 66 on signal path 50 (e.g., between input node 56 and the input of amplifier 60-1, between the output of amplifier 60-1 and the input of amplifier 60-2, between the output of amplifier 60-2 and signal combiner 62, between signal combiner 62 and the input of amplifier 60-3, between the output of amplifier 60-3 and the input of mixer 64, and/or between the output of mixer 64 and output node 54) to adjust or fine tune the power level of signal sig prior to providing signal sig to amplifier 60-1, amplifier 60-2, signal combiner 62, amplifier 60-3, mixer 64, and/or output node 54. Signal attenuators at nodes 66 may, for example, help to perform gain tuning, amplitude equalization, isolation, and/or matching for signal sig. The example of FIG. 4 is illustrative and non-limiting. In general, signal path 50 may include any desired components 56 and any desired signal attenuators 58 at any desired location along the signal path.

In some scenarios, signal attenuators 58 are implemented as resistive step attenuators. Resistive step attenuators include pi-type attenuators and T-type attenuators. In a pi-type attenuator, an adjustable series resistor is disposed on signal path 50 and coupled in series between an input node and an output node of the attenuator. Signal sig flows through the adjustable series resistor. First and second adjustable shunt resistors are coupled between the ends of the adjustable series resistor and ground. In a T-type attenuator, first and second adjustable series resistors are disposed on signal path 50 and coupled in series between an input node and an output node of the attenuator. Signal sig flows through both the first and second adjustable series resistors. An adjustable shunt resistor couples a node on the signal path between the first and second adjustable series resistors and ground.

The adjustable resistors in T-type and pi-type attenuators include switches that are adjusted to tune the resistance of the adjustable resistors, which changes the relative amount of the incident signal shunted to ground and thus the level of attenuation performed by the attenuator. However, switching components coupled in series along signal path 50 such as the adjustable series resistors in pi-type and T-type attenuators always produce non-zero insertion loss to the signal sig passing along signal path 50 (e.g., at least a 1 dB insertion loss), which can degrade wireless communications performance using signal sig. In addition, resistive step attenuators exhibit a relatively limited tuning range (e.g., a limited range of attenuation levels).

To reduce the amount of insertion loss produced by the signal attenuator, to increase the tuning (attenuation) range of the signal attenuator, and to maximize the flexibility with which the signal attenuator can be implemented on a substrate in device 10, the signal attenuators 58 in signal path 50 may include transmission line-based signal attenuators. Signal attenuators 58 are therefore sometimes also referred to herein as transmission-line based signal attenuators 58 or more simply as transmission line attenuators 58.

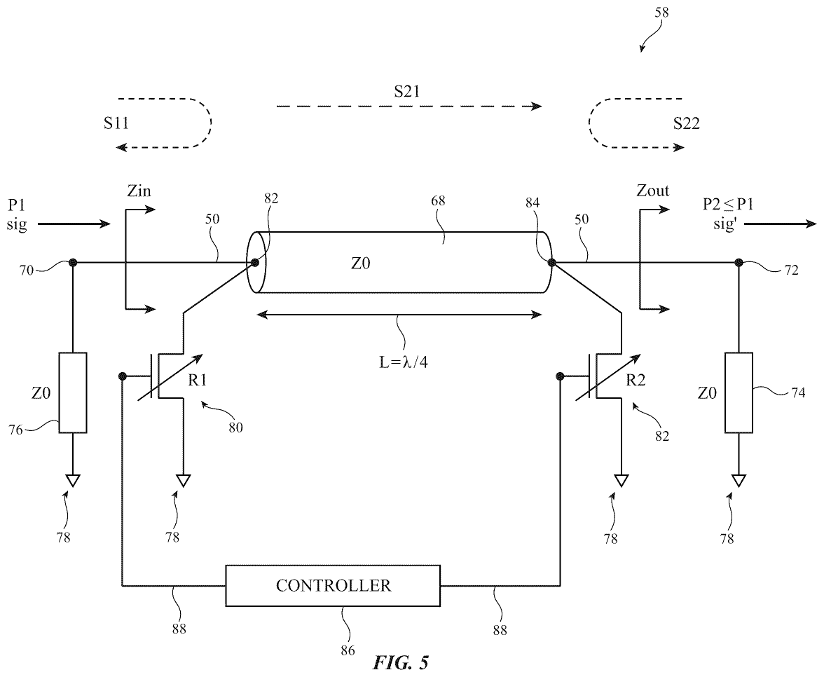

FIG. 5 is a circuit diagram of an illustrative transmission-line based signal attenuator 58. As shown in FIG. 5, transmission-line based signal attenuator 58 may have an input node 70 and an output node 72 disposed along signal path 50. Input node 70 is sometimes also referred to herein as input terminal 70 or input port 70 of transmission-line based signal attenuator 58. Output node 72 is sometimes also referred to herein as output terminal 72 or output port 72 of transmission-line based signal attenuator 58.

Rather than including an adjustable resistor coupled in series between input node 70 and output node 72 (as in resistive step attenuators), transmission-line based signal attenuator 58 may instead include a transmission line segment 68 coupled in series between input node 70 and output node 72. Transmission line segment 68 may have a first terminal 82 communicatively coupled to input node 70. Transmission line segment 68 may have an opposing second terminal 84 communicatively coupled to output node 72. Transmission line segment 68 may extend from terminal 82 to terminal 84 and may have a length L measured from terminal 82 to terminal 84. Terminals 82 and 84 are sometimes also referred to herein as nodes 82 and 84.

Transmission line segment 68 is sometimes also referred to herein simply as transmission line 68. Transmission line 68 may be formed using any desired transmission line structures (e.g., one or more coaxial cables, microstrip transmission lines, stripline transmission lines, edge-coupled microstrip transmission lines, edge-coupled stripline transmission lines, twisted pair cables, slotlines, waveguides, etc.). A transmission line such as transmission line segment 68 includes at least a first conductor (e.g., a signal conductor) and a second conductor (e.g., a ground or reference conductor) extending between the at least first and second nodes such as terminals 82 and 84 (e.g., where the first and second conductors propagate electromagnetic waves at radio frequencies between the at least first and second nodes). A transmission line can include one or more shielding structures that provide electrical isolation from nearby circuitry and/or that help to facilitate the propagation of electromagnetic energy at radio-frequencies between the at least first and second nodes. Not all signal lines are transmission lines. For instance, a generic signal wire that carries digital and/or analog signals at lower frequencies than around 20 kHz, that is not optimized for minimal signal loss at radio frequencies, and/or that is not properly terminated at radio frequencies is not a “transmission line” or a “transmission line segment” as defined herein.

Transmission-line based signal attenuator 58 may also include adjustable shunt resistances such as adjustable resistance R1 and adjustable resistance R2. Adjustable resistance R1 may be coupled between terminal 82 of transmission line segment 68 and a reference potential such as ground 78. Adjustable resistance R2 may be coupled between terminal 84 of transmission line segment 68 and a reference potential such as ground 78. Transmission line segment 68 couples adjustable resistance R1 to adjustable resistance R2 via a portion of signal path 50 (e.g., the portion formed from transmission line segment 68 may couple adjustable resistance R1 to adjustable resistance R2) that is free from adjustable resistances and switches (i.e., there are no switches or adjustable resistances along the entire length of transmission line segment 68 from terminal 82 to terminal 84). Adjustable resistances R1 and R2 are sometimes also referred to herein as adjustable resistors, adjustable shunt resistors, or adjustable shunt resistances.

Adjustable resistances R1 and R2 may receive control signals from controller 86 (e.g., a controller forming part of control circuitry 14 of FIG. 1) over one or more control paths 88. The control signals may be digital control signals or may be analog control signals. The control signals may set adjustable resistances R1 and R2 to desired magnitudes and/or may adjust adjustable resistances R1 and R2 between different magnitudes over time. During transmission of signal sig along signal path 50, the magnitude of adjustable resistances R1 and R2 determines the amount of signal sig that is shunted off of signal path 50 to ground 78, effectively reducing (attenuating) the power of signal sig from an input power level P1 at input node 70 to an output power level P2 at output node 72. Output power level P2 may be less than input power level P1 or may be equal to power level P1 when transmission-line based signal attenuator 58 is configured not to perform any attenuation on signal sig. The attenuation level of transmission-line based signal attenuator 58 may, for example, be given by the difference between output power level P2 and input power level P1. Controller 86 may use control signals provided over control paths 88 to set the attenuation level of transmission-line based signal attenuator 58 by setting adjustable resistances R1 and R2 to suitable magnitudes. Controller 86 may use the control signals to change the attenuation level of transmission-line based signal attenuator 58 over time by changing the magnitudes of adjustable resistances R1 and/or R2 over time.

Adjustable resistances R1 and R2 may be implemented using any desired adjustable resistors and/or resistive components. As one example, adjustable resistance R1 may include one or more transistors such as transistor 80 and adjustable resistance R2 may include one or more transistors such as transistor 82. The terms “source” and “drain” terminals used to refer to current-conveying terminals in a transistor may be used interchangeably and are sometimes referred to as “source-drain” terminals. Thus, the drain terminal of transistor 80 can sometimes be referred to as a first source-drain terminal, and the source terminal of transistor 80 can be referred to as a second source-drain terminal (or vice versa).

Transistor 80 may have a first source-drain terminal coupled to terminal 82 of transmission line segment 68. Transistor 80 may have a second source-drain terminal coupled to ground 78. Transistor 80 may have a gate terminal coupled to control circuitry such as controller 86 over one or more control paths 88. Transistor 82 may have a first source-drain terminal coupled to terminal 84 of transmission line segment 68. Transistor 82 may have a second source-drain terminal coupled to ground 78. Transistor 82 may have a gate terminal coupled to controller 86 over one or more control paths 88.

Controller 86 may, for example, supply analog control signals to the gate terminals of transistors 80 and 82. The control signal may supply a gate voltage to transistor 80 that sets a desired source-drain voltage between the first and second source-drain terminals of transistor 80. This also sets the magnitude of adjustable resistance R1 and the amount of signal sig shunted off of signal path 50 through adjustable resistance R1. At the same time, the control signal may supply a gate voltage to transistor 82 that sets a desired source-drain voltage between the first and second source-drain terminals of transistor 82. This also sets the magnitude of adjustable resistance R2 and the amount of signal sig shunted off of signal path 50 through adjustable resistance R2 (e.g., to configure transmission-line based signal attenuator 58 to exhibit a desired attenuation level or, equivalently, to configure transmission-line based signal attenuator 58 to output signal sig at output power level P2 given its input power level P1).

As another example, adjustable resistance R1 may be implemented using a first bank of transistors and adjustable resistance R2 may be implemented using a second bank of transistors. In this example, controller 86 may supply digital control signals to the gate terminals of each bank of transistors to set the magnitude of the adjustable resistance exhibited by the banks of transistors. The digital control signal may, for example, be asserted at a logic high level to turn on corresponding transistors in each bank (e.g., causing the transistors to exhibit greater than a threshold level of transconductance between their source-drain terminals, causing the transistors to exhibit less than a threshold impedance between their source-drain terminals, and/or causing current to flow between their source-drain terminals) and may be de-asserted (e.g., provided at a logic low level) to turn off corresponding transistors in each bank (e.g., causing the transistors to exhibit less than a threshold level of transconductance between their source-drain terminals, causing the transistors to exhibit greater than a threshold impedance between their source-drain terminals, and/or stopping current flow between their source-drain terminals) such that each bank collectively exhibits an adjustable resistance of a desired magnitude. These examples are illustrative and, in general, adjustable resistances R1 and R2 may be implemented using any desired resistive components, switching components, transistors, etc.

In some configurations, adjustable resistance R1 may be set to the same magnitude as adjustable resistance R2. In these implementations, adjustable resistances R1 and R2 symmetrically load transmission line segment 68 (e.g., by equal amounts at terminals 82 and 84). This configures transmission line-based signal attenuator 58 to form a symmetric transmission line-based signal attenuator. In other configurations, adjustable resistance R1 may be set to exhibit a different magnitude than adjustable resistance R2. In these implementations, adjustable resistances R1 and R2 asymmetrically load transmission line segment 68 (e.g., by different amounts at terminals 82 and 84). This configures transmission line-based signal attenuator 58 to form an asymmetric transmission line-based signal attenuator.

As shown in FIG. 5, there may be an arbitrary input load 76 of impedance Z0 (e.g., 50 Ohms) coupled between input node 70 and ground 78. There may also be an arbitrary output load 74 of impedance Z0 coupled between output node 72 and ground 78. Transmission-line based signal attenuator 58 may exhibit an input impedance Zin (e.g., facing away from input node 70 and towards terminal 82 of transmission line segment 68) and an output impedance Zout (e.g., facing out of terminal 84 of transmission line segment 68 and towards output node 72). The length L of transmission line segment 68 may be selected to perform suitable impedance matching between input impedance Zin and output impedance Zout given the settings (magnitudes) of adjustable resistances R1 and R2. Length L may, for example, be approximately equal to (e.g., within 15% of) one-quarter of the wavelength λ of the signal sig propagating along signal path 50 between input node 70 and output node 72. When configured in this way, transmission line segment 68 is sometimes also referred to as a quarter wave impedance transformer and transmission line-based signal attenuator 58 is sometimes also referred to herein as a quarter-wavelength transmission line-based signal attenuator 58.

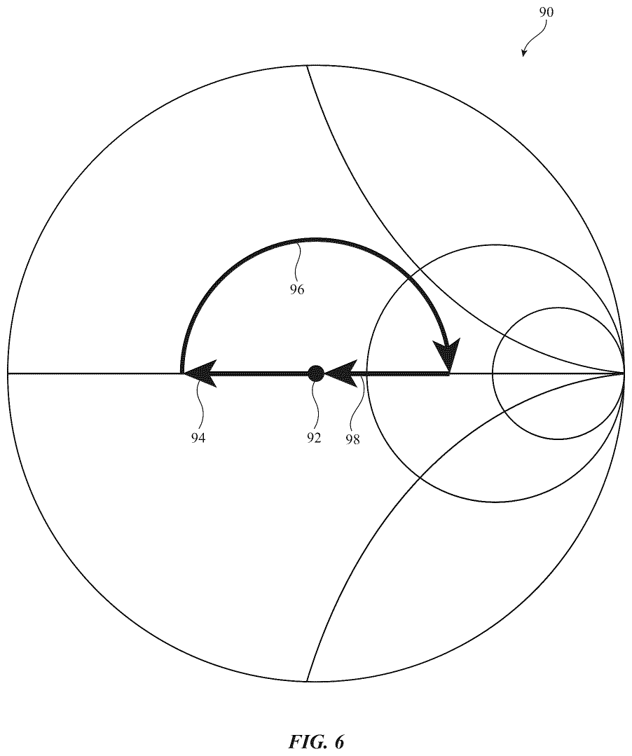

FIG. 6 shows a Smith chart 90 illustrating how transmission line segment 68 may perform impedance matching for transmission line-based signal attenuator 58 in an example where adjustable resistances R1 and R2 have the same magnitude (e.g., when transmission line-based signal attenuator 58 is configured to form a symmetric quarter-wavelength transmission line-based signal attenuator 58).

Point 92 at the center of Smith chart 90 represents a nominal (50 Ohm) impedance (e.g., as experienced by signal sig propagating along signal path 50 and incident upon the attenuator at input node 70). Adjustable resistance R1 may shift the signal away from point 92 as shown by arrow 94. Signal sig may propagate by one-quarter of its wavelength along transmission line segment 68. As such, transmission line segment 68 may effectively shift the phase of signal sig by one-quarter of its wavelength. This shifts the signal away from the tip of arrow 94 as shown by arrow 96. Finally, adjustable resistance R2, which has the same magnitude as adjustable resistance R1 in this example, shifts the signal from the tip of arrow 96 back to point 92 as shown by arrow 98, which is of equal magnitude and direction as arrow 94 (e.g., matching the nominal impedance of the signal along signal path 50 prior to reaching input node 70 of the attenuator).

Returning to FIG. 5, the propagation of signal sig through transmission line-based signal attenuator 58 may be characterized by corresponding complex scattering parameters (sometimes also referred to as S-parameters). The scattering parameters include a first scattering parameter S11 (sometimes also referred to as the reflection coefficient at the input of transmission line-based signal attenuator 58) characterizing the amount of the incident signal sig that is reflected from input node 70 off transmission line-based signal attenuator 58 and back towards input node 70 (e.g., due to an impedance discontinuity between input impedance Zin and impedance Z0). The scattering parameters also include a second scattering parameter S22 (sometimes also referred to as the reflection coefficient at the output of transmission line-based signal attenuator 58) characterizing the amount of the signal sig that is reflected from output node 72 off transmission line-based signal attenuator 58 and back output node 72 (e.g., due to an impedance discontinuity between input impedance Zout and impedance Z0). The scattering parameters further include a third scattering parameter S21 (sometimes also referred to as the forward or transmission coefficient of transmission line-based signal attenuator 58) characterizing the amount of the signal sig incident upon input node 70 that is passed onto output node 72 through transmission line-based signal attenuator 58. In general, scattering parameter S21 will exhibit a relatively low magnitude when the attenuation level of transmission line-based signal attenuator 58 is set relatively high and will exhibit a relatively high magnitude when the attenuation level of transmission line-based signal attenuator 58 is set relatively low.

In general, when implemented as a symmetric transmission line-based signal attenuator, the operation of transmission line-based signal attenuator 58 can be characterized by a factor g=Z0/R, where R is equal to the magnitude of both adjustable resistances R1 and R2.

Input impedance Zᵢₙ is a function of Z0 and factor g, as given by the equation Zᵢₙ=Z0*[(1/(1+g)+g]⁻¹≈Z0*[1−g+g]⁻¹=Z0. The magnitude |S21| of scattering parameter S21 is then given by the equation |S21|=2/[(1+g)²+1].

When configured in this way, the magnitude of scattering parameter S11 is minimal (e.g., less than −17 dB) at the frequencies of signal sig in a frequency band from a frequency FA (e.g., 35 GHz) to a frequency FB (e.g., 50 GHz) across all magnitudes R of adjustable resistances R1 and R2. Put differently, the impedance matching performed by transmission line segment 68 effectively minimizes the amount of signal reflected from input node 70 back to input node 70. The magnitude of scattering parameter S22 is minimal (e.g., less than −17 dB) at the frequencies of signal sig in the frequency band from frequency FA to frequency FB across all magnitudes R of adjustable resistances R1 and R2. Put differently, the impedance matching performed by transmission line segment 68 effectively minimizes the amount of signal reflected from output node 72 back to output node 72. The magnitude of scattering parameter S21 corresponds to the amount of signal attenuation performed by the attenuator. Transmission line-based signal attenuator 58 may exhibit a relatively wide gain range between its lowest level of attenuation and its highest level of attenuation (e.g., as high as 5-6 dB).

At the same time, transmission line-based signal attenuator 58 contributes less insertion loss to the attenuated signal sig (e.g., when configured to exhibit its lowest attenuation level) than resistive step attenuators because transmission line-based signal attenuator 58 only includes transmission line segment 68 coupled in series between input node 70 and output node 72 and does not include any adjustable resistors or switches coupled in series between input node 70 and output node 72. In addition, transmission line segment 68 may be implemented using transmission line routings already present on signal path 54 and may be flexibly placed and routed on its corresponding substrate (e.g., reducing the footprint of transmission line-based signal attenuator 58 relative to resistive step attenuators).

Consider another example in which transmission line-based signal attenuator 58 is configured to from an asymmetric quarter-wavelength transmission line-based signal attenuator. In this example, transmission ling segment 68 has a length L=λ/4, adjustable resistance R1 is set to exhibit a first magnitude RA, and adjustable resistance R2 is set to exhibit a second magnitude RB that is different than the magnitude RA of adjustable resistance R1. Transmission line-based signal attenuator 58 may exhibit an additional input impedance Zᵢₙ₂ facing transmission line segment 68 from output node 72.

In this configuration, the operation of transmission line-based signal attenuator 58 can be characterized by a first factor g1=Z0/RA and a second factor g2=Z0/RB. Input impedance Zᵢₙ is given by the equation Zᵢₙ=Z0*[(1/(1+g2)+g1]⁻¹ and Zᵢₙ₂ is given by the equation Zᵢₙ₂=Z0*[(1/(1+g1)+g2]⁻¹. The magnitude |S21| of scattering parameter S21 is then given by the equation |S21|=2/[(1+g1)*(1+g2)+1]. If g2=g1/(1-g1) or RB=RA-Z0, then Zᵢₙ=Z0 and |S21|=1-g1. The attenuation range of transmission line-based signal attenuator 58 can be further extended (e.g., beyond the attenuation range when implemented as a symmetric quarter-wavelength transmission line-based signal attenuator) if input matching at deep back-off can be relaxed on one side, especially in implementations where matching on only one side of the attenuator is important.

In these configurations, the magnitude of scattering parameter S11 is minimal (e.g., less than −17 dB) at the frequencies of signal sig in the frequency band from frequency FA to frequency FB across all magnitudes R of adjustable resistances R1 and R2. Put differently, the impedance matching performed by transmission line segment 68 effectively minimizes the amount of signal reflected from input node 70 back to input node 70. The magnitude of scattering parameter S22 is relatively low (e.g., less than −5.4 dB) at the frequencies of signal sig in the frequency band from frequency FA to frequency FB across all magnitudes R of adjustable resistances R1 and R2. Put differently, the impedance matching performed by transmission line segment 68 effectively limits the amount of signal reflected from output node 72 back to output node 72. Transmission line-based signal attenuator 58 may exhibit a relatively wide gain range 138 between its lowest level of attenuation and its highest level of attenuation (e.g., as high as 11-12 dB).

The example of FIG. 5 in which transmission line segment 68 has a length L=λ/4 is illustrative and non-limiting. If desired, transmission line segment 68 may have other lengths (e.g., shorter or longer lengths). As another example, length L may be approximately equal to (e.g., within 15% of) one-eighth of wavelength λ. When configured in this way, transmission line segment 68 is sometimes also referred to as an eighth wave impedance transformer and transmission line-based signal attenuator 58 is sometimes also referred to herein as an eighth-wavelength transmission line-based signal attenuator 58.

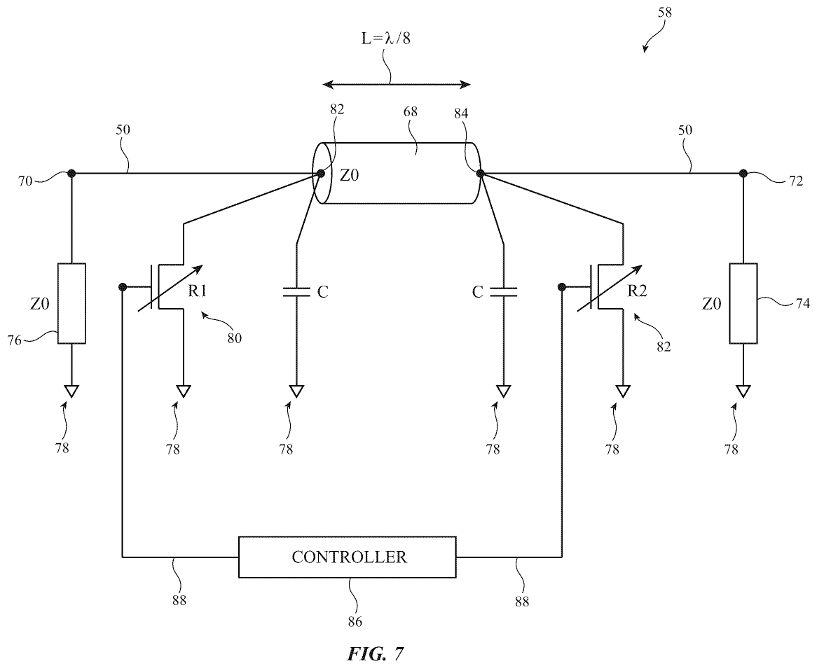

FIG. 7 is a circuit diagram showing an example in which transmission line-based signal attenuator 58 is implemented as an eighth-wavelength transmission line-based signal attenuator. As shown in FIG. 7, transmission line segment 68 may have a length L=λ/8. To help counteract the impedance effects of reducing the length L of transmission line segment 68, transmission line-based signal attenuator 58 may include additional capacitors C coupled between terminals 82 and ground 78. Implementing transmission line-based signal attenuator 58 as an eighth-wavelength transmission line-based signal attenuator in this way may, for example, allow transmission line-based signal attenuator 58 to be integrated into segments of signal path 50 (e.g., between adjacent components 56 of FIG. 3) that are shorter than when implemented as a quarter-wavelength transmission line-based signal attenuator.

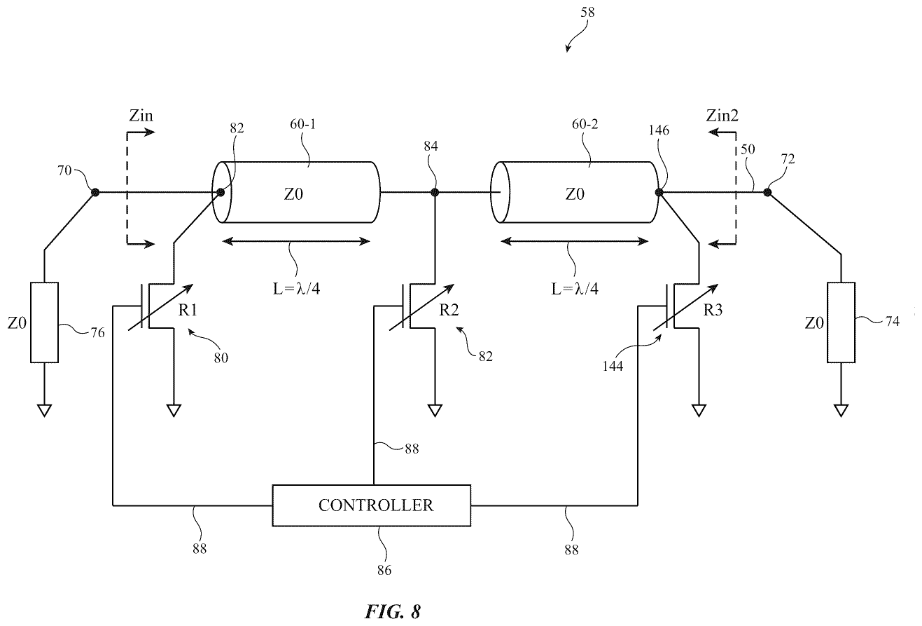

As another example, transmission line-based signal attenuator 58 may be implemented as a half-wavelength transmission line-based signal attenuator. FIG. 8 is a circuit diagram showing one example in which transmission line-based signal attenuator 58 is implemented as a half-wavelength transmission line-based signal attenuator. As shown in FIG. 8, transmission line-based signal attenuator 58 may include a first transmission line segment 68-1 of length L=λ/4 and a second transmission line segment 68-2 of length L=λ/4 coupled in series between input node 70 and output node 72.

Transmission line segment 68-1 may extend from terminal 82 to terminal 84. Transmission line segment 68-2 may extend from terminal 84 to an opposing terminal 146. Transmission line-based signal attenuator 58 may include an additional adjustable resistance R3 coupled between terminal 146 and ground. Adjustable resistance R3 may be implemented using a transistor such as transistor 144 or using any other desired components. Transistor 144 may have a first source-drain terminal coupled to terminal 146 and may have a second source-drain terminal coupled to ground. The gate terminal of transistor 144 may be coupled to controller 86 over control paths 88.

Controller 86 may set the attenuation level of transmission line-based signal attenuator 58 by setting the magnitudes of adjustable resistances R1, R2, and R3. If desired, controller 86 may configure transmission line-based signal attenuator 58 to form a symmetric half-wavelength transmission line-based signal attenuator by setting the magnitude of adjustable resistances R1 and R3 both equal to a first magnitude RA and by setting the magnitude of adjustable resistance R2 to equal a second magnitude RB.

When configured in this way, the input impedance Zᵢₙ of transmission line-based signal attenuator 58 is given by the equation Zᵢₙ=Z0*[(1/(1/(1+g1)+g2)+g1]⁻¹ and the magnitude |S21|of scattering parameter S21 is then given by the equation |S21|=2/[(1+g1)*(2+g2+g1*g2)]. If g2=2*g1/(1-g12) or 2*RB=RA-Z0²/RA, then Zᵢₙ=Zᵢₙ₂=Z0 and |S21|=(1-g1)/(1+g1).

In this implementation, the magnitude of scattering parameter S11 is minimal (e.g., less than −16 dB) at the frequencies of signal sig in the frequency band from frequency FA to frequency FB across all magnitudes R of adjustable resistances R1 and R2. Put differently, the impedance matching performed by transmission line segment 68 effectively minimizes the amount of signal reflected from input node 70 back to input node 70. At the same time, the magnitude of scattering parameter S22 is minimal (e.g., less than −16 dB) at the frequencies of signal sig in the frequency band from frequency FA to frequency FB across all magnitudes R of adjustable resistances R1 and R2. Put differently, the impedance matching performed by transmission line segment 68 effectively limits the amount of signal reflected from output node 72 back to output node 72. Further, transmission line-based signal attenuator 58 may exhibit a very wide gain range between its lowest level of attenuation and its highest level of attenuation (e.g., as high as 26 dB). Transmission line segment 68 may have other lengths if desired (e.g., with corresponding impedance adjustments between terminals 82 and 84 and ground).

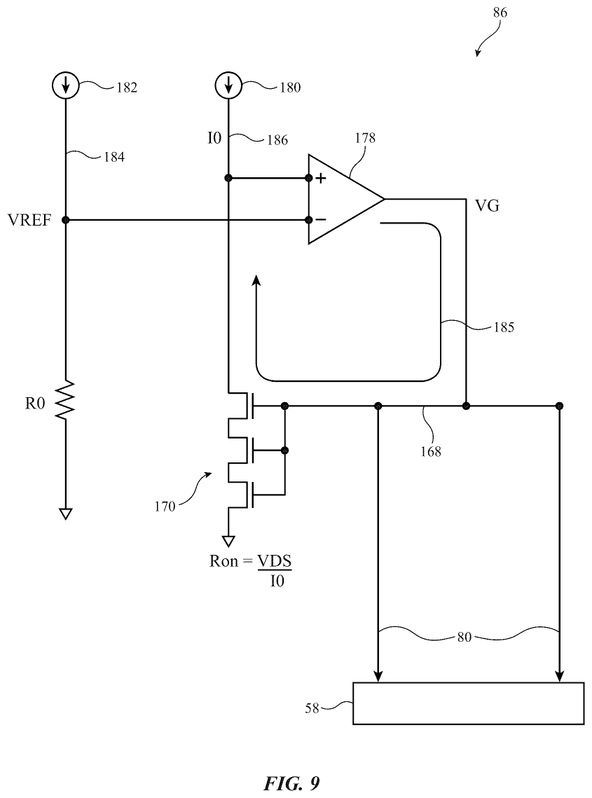

Controller 86 may be implemented using any desired control circuitry. FIG. 9 is a circuit diagram showing one example of control circuitry that may be used to form controller 86. As shown in FIG. 9, controller 86 may include an operational amplifier 178, a bank of transistors 170 (e.g., NMOS transistors), a first current source 182, a second current source 180, and a resistance R0.

Current source 182 may be coupled to ground over a first current path such as reference line 184. Resistance R0 may be coupled in series on reference line 184 between current source 182 and ground. Current source 180 may be coupled to transistors 170 over a second current path such as reference line 186. The source-drain terminals of transistors 170 may be coupled in series between ground and reference line 186. The gate terminals of transistors 170 may be coupled to gate line 168.

Operational amplifier 178 may have a first (e.g., positive) input coupled to a node on reference line 186 between resistance R0 and current source 182. Operational amplifier 178 may have a second (e.g., negative) input coupled to a node on reference line 184 between current source 180 and transistors 170. The output of operational amplifier 178 may be coupled to gate line 168. The control paths 80 used to control adjustable resistances R1, R2, and/or R3 may be coupled to gate line 168.

Current source 182 may output a first current onto reference line 184. The first current may be equal to a band gap voltage divided by the magnitude of resistance R0. The band gap voltage may be very stable across process, voltage, and temperature (PVT) variations in device 10. A reference voltage VREF may be produced on reference line 184 and may be supplied to the second input of operational amplifier 178. Current source 180 may output a second current I0 onto reference line 186. Current source 180 may be a constant current source and current I0 may be a constant current across PVT variations (e.g., as trimmed for device 10).

Operational amplifier 178 may amplify the difference between its first and second inputs to produce an output voltage such as regulated voltage VG on gate line 168. Regulated voltage VG may drive the gate terminals of transistors 170 over gate line 168, causing current to flow through the source-drain terminals of transistors 170, until the effective resistance Ron through the source-drain terminals of transistors 170 (e.g., where Ron is equal to the source-drain voltage VDS of the transistors divided by I0) equals resistance R0. This may effectively form a servo loop 185 (e.g., a Ron servo or regulation loop) around operational amplifier 178 (e.g., from the output of operational amplifier 178 through gate line 168, transistors 170, and reference line 186 to the positive input of the operational amplifier). The servo loop may cause the operational amplifier to output a regulated voltage VG onto control paths 80 (for driving the adjustable resistances of the signal attenuator) that is constant across PVT variations in device 10.

In this way, controller 86 may help to mitigate PVT variations in device 10 that could otherwise impact the signal attenuation performed by transmission-line based signal attenuator 58. In practice, adjustable resistances are highly susceptible to PVT variations. In the absence of servo loop 184, PVT variations can impact adjustable resistances R1, R2, and/or R3 in transmission-line based signal attenuator 58 more than transmission line segment 68, leading to an uncompensated mismatch between the shunt and series paths of the attenuator. Regulating the output of controller 86 using servo loop 184 may help to mitigate this uncompensated mismatch to optimize the performance of transmission-line based signal attenuator 58. This is illustrative and, in general, controller 86 may have other architectures.

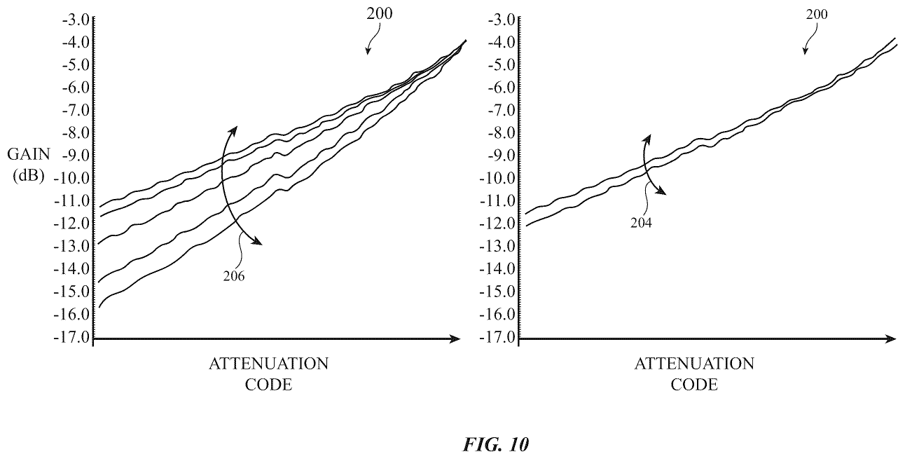

FIG. 10 is a plot of gain as a function of attenuation code (e.g., settings for the adjustable resistances in the attenuator) for transmission line-based signal attenuator 58. Curves 200 plot the gain of transmission-line based signal attenuator 58 at different PVT levels (e.g., across PVT variations) in the absence of servo loop 185. Curves 202 plot the gain of transmission-line based signal attenuator 58 at different PVT levels when the adjustable resistances are driven using servo loop 185. As shown by arrows 206 and 204, servo loop 185 may serve to greatly reduce variation in the gain of transmission-line based signal attenuator 58 across PVT variations (e.g., by a factor of eight or more).

The examples of FIGS. 5, 7, and 8 illustrate transmission line segments 68 as distributed transmission lines (sometimes also referred to as “real” transmission lines). This is illustrative and non-limiting. If desired, any of the transmission line segments 68 described herein may be implemented using a lumped LC circuit (sometimes also referred to as a lumped LC transmission line). In these implementations, a transmission line segment 68 having a length L=λ/4 may be implemented using a 90-degree phase shift between the input and the output of the lumped LC circuit.

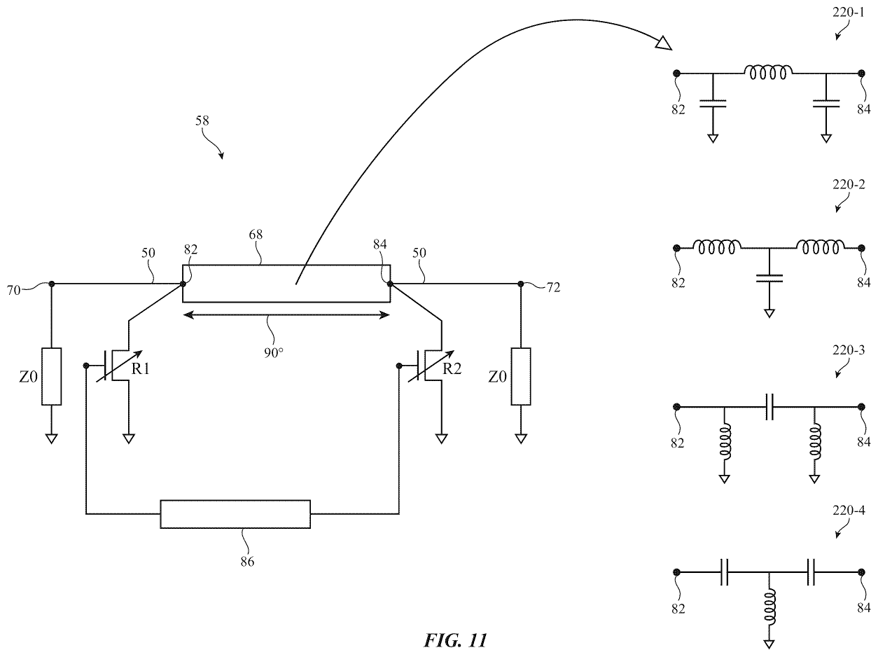

FIG. 11 illustrates a few non-limiting examples of lumped LC circuits 220 that may be used to form a 90-degree phase shift between terminals 82 and 84 of signal attenuator 58. As a first example, the 90-degree phase shift may be formed using a lumped LC circuit 220-1 (e.g., a three element pi lumped line) having a series inductor coupled between terminals 82 and 84 and having shunt capacitors coupled to either end of the series inductor. As a second example, the 90-degree phase shift may be formed using a lumped LC circuit 220-2 (e.g., a three element T lumped line) having two series inductors coupled between terminals 82 and 84 and having a shunt capacitor coupled between the series inductors. As a third example, the 90-degree phase shift may be formed using a lumped LC circuit 220-3 (e.g., a three element pi lumped line) having a series capacitor coupled between terminals 82 and 84 and having shunt inductors coupled to either end of the series capacitor. As a fourth example, the 90-degree phase shift may be formed using a lumped LC circuit 220-4 (e.g., three element T lumped line) having two series capacitors coupled between terminals 82 and 84 and having a shunt inductor coupled between the series capacitors. These examples are illustrative and non-limiting and, in general, lumped LC circuit 220 may include any desired inductors and capacitors coupled together in any desired manner. The absence of resistive components in lumped LC circuits 220 may prevent transmission line segment 68 from introducing the non-zero insertion loss otherwise produced by resistive T or Pi circuits.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.”

The methods and operations described above may be performed by the components of device 10 using software, firmware, and/or hardware (e.g., dedicated circuitry or hardware). Software code for performing these operations may be stored on non-transitory computer readable storage media (e.g., tangible computer readable storage media) stored on one or more of the components of device 10 (e.g., storage circuitry 16 of FIG. 1). The software code may sometimes be referred to as software, data, instructions, program instructions, or code. The non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of device 10 (e.g., processing circuitry 18 of FIG. 1, etc.). The processing circuitry may include microprocessors, central processing units (CPUs), application-specific integrated circuits with processing circuitry, or other processing circuitry.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing is illustrative and various modifications can be made to the described embodiments. The foregoing embodiments may be implemented individually or in any combination.

What is claimed is:

1. Circuitry comprising:
a signal path configured to convey a radio-frequency signal; and
an adjustable attenuator disposed on the signal path and configured to attenuate the radio-frequency signal, wherein the adjustable attenuator has an input terminal and an output terminal and includes
a transmission line segment coupled in series between the input terminal and the output terminal,
a first adjustable resistance coupled between a first terminal of the transmission line segment and a reference potential, and
a second adjustable resistance coupled between a second terminal of the transmission line segment and the reference potential.

2. The circuitry of claim 1, wherein the transmission line segment extends from the first terminal to the second terminal and has a length equal to one-quarter of a wavelength of the radio-frequency signal.

3. The circuitry of claim 2, wherein the adjustable attenuator is configured to attenuate the radio-frequency signal while the first adjustable resistance has a first magnitude and while the second adjustable resistance concurrently has the first magnitude.

4. The circuitry of claim 2, wherein adjustable attenuator is configured to attenuate the radio-frequency signal while the first adjustable resistance has a first magnitude and while the second adjustable resistance concurrently has a second magnitude different than the first magnitude.

5. The circuitry of claim 2, further comprising:
an additional transmission line segment coupled in series with the transmission line segment between the input terminal and the output terminal, wherein the additional transmission line segment extends from a third terminal to a fourth terminal, the third terminal being coupled to the second terminal and the second adjustable resistance.

6. The circuitry of claim 5, further comprising:
a third adjustable resistance coupled between the fourth terminal and the reference potential.

7. The circuitry of claim 6, wherein the additional transmission line segment has an additional length equal to one-quarter of the wavelength of the radio-frequency signal.

8. The circuitry of claim 7, wherein adjustable attenuator is configured to attenuate the radio-frequency signal while the first adjustable resistance has a first magnitude, while the second adjustable resistance concurrently has a second magnitude different than the first magnitude, and while the third adjustable resistance concurrently has the first magnitude.

9. The circuitry of claim 1, wherein the transmission line segment extends from the first terminal to the second terminal and has a length equal to one-eighth of a wavelength of the radio-frequency signal.

10. The circuitry of claim 9, further comprising:
a first capacitor coupled between the first terminal and the reference potential; and
a second capacitor coupled between the second terminal and the reference potential.

11. The circuitry of claim 1, wherein:
the first adjustable resistance comprises a first transistor having a first source-drain terminal coupled to the first terminal and having a second source-drain terminal coupled to the reference potential;
the second adjustable resistance comprises a second transistor having a third source-drain terminal coupled to the second terminal and having a fourth source-drain terminal coupled to the reference potential; and
the circuitry further comprises a controller configured to apply one or more voltages to a first gate terminal of the first transistor and to a second gate terminal of the second transistor.

12. The circuitry of claim 11, wherein the controller comprises:
a first current source;
a second current source;
a first conductive line that couples the first current source to the reference potential;
a resistor disposed on the first conductive line;
a set of transistors;
a second conductive line coupled to the second current source, wherein source-drain terminals of the set of transistors are coupled in series between the second conductive line and the reference potential;
a third conductive line coupled to gate terminals of the set of transistors;
an operational amplifier having a first input coupled to a node on the first conductive line between the resistor and the first current source, a second input coupled to the second conductive line, and an output coupled to the third conductive line; and
control paths that couple the third conductive line to the first and second gate terminals, wherein the operational amplifier is configured to output a voltage onto the third conductive line that sets the first and second adjustable resistances to one or more magnitudes.

13. The circuitry of claim 1, wherein the transmission line segment does not include any switches or adjustable resistances.

14. A radio-frequency signal attenuator disposed on a signal line and comprising:
a transmission line extending from a first terminal to a second terminal, the first terminal being coupled to an input of the radio-frequency signal attenuator and the second terminal being communicatively coupled to an output of the radio-frequency signal attenuator;
a first adjustable resistance that couples the first terminal to a ground; and
a second adjustable resistance that couples the second terminal to the ground, wherein the transmission line has a length from the first terminal to the second terminal that is configured to match an input impedance of the radio-frequency signal attenuator to an impedance of the signal line.

15. The radio-frequency signal attenuator of claim 14, wherein the radio-frequency signal attenuator is configured to convey a radio-frequency signal at a wavelength, the length being equal to one-quarter of the wavelength.

16. The radio-frequency signal attenuator of claim 15, further comprising:
an additional transmission line extending from a third terminal to a fourth terminal, wherein the third terminal is coupled to the second terminal, the fourth terminal is coupled to the output of the radio-frequency signal attenuator, and the additional transmission line has an additional length equal to one-quarter of the wavelength; and
a third adjustable resistance that couples the fourth terminal to the ground.

17. The radio-frequency signal attenuator of claim 14, wherein the radio-frequency signal attenuator is configured to convey a radio-frequency signal at a wavelength, the length is equal to one-eighth of the wavelength, and the radio-frequency signal attenuator further comprises:
a first capacitor that couples the first terminal to the ground; and
a second capacitor that couples the second terminal to the ground.

18. An electronic device comprising:
a signal path configured to convey a radio-frequency signal;
an attenuator disposed on the signal path, wherein the attenuator is configured to attenuate the radio-frequency signal and includes first and second adjustable shunt resistances; and
a controller configured to adjust a magnitude of the first and second adjustable shunt resistances, wherein the controller includes
an operational amplifier having an output communicatively coupled to the first and second adjustable shunt resistances,
a set of transistors having gate terminals communicatively coupled to the output of the operational amplifier, and
a servo loop extending around the operational amplifier from the output of the operational amplifier to a first input of the operational amplifier through the set of transistors.

19. The electronic device of claim 18, wherein the controller further comprises:
a first current source;
a first conductive line that couples the first current source to a ground;
a resistance disposed on the first conductive line, wherein a node on the first conductive line between the first current source and the resistance is coupled to a second input of the operational amplifier;
a second current source; and
a second conductive line that couples the second current source to the set of transistors, wherein the second conductive line is coupled to the first input of the operational amplifier.

20. The electronic device of claim 18, the attenuator comprising:
a transmission line that is free from switches and adjustable resistances and that is coupled in series along the signal path, wherein the first adjustable shunt resistance is coupled to a first end of the transmission line and the second adjustable shunt resistance is coupled to a second end of the transmission line opposite the first end.
